(19) United States
(12) Patent Application Publication
(10) Pub. No.: US 2023/0372922 A1
(43) Pub. Date: Nov. 23, 2023

(54) A METHOD OF PREPARING A HYDROCRACKING CATALYST

(71) Applicant: SHELL OIL COMPANY, HOUSTON, TX (US)

(72) Inventors: Johan Peter DEN BREEJEN, Amsterdam (NL); Cornelis OUWEHAND, Amsterdam (NL); Marcello Stefano RIGUTTO, Amsterdam (NL)

(21) Appl. No.: 18/248,707

(22) PCT Filed: Nov. 11, 2021
(86) PCT No.: PCT/EP2021/081350

§ 371 Date: Apr. 12, 2023

(30) Foreign Application Priority Data
Nov. 12, 2020 (EP) 20207174.2

(51) Int. Cl. B01J 37/02; B01J 29/12; B01J 37/08; B01J 35/10; C10G 47/20

(52) U.S. Cl. CPC B01J 37/0201; B01J 29/126; B01J 37/088; B01J 35/1061; C10G 47/20

(57) ABSTRACT

The present invention provides a method of preparing a supported catalyst, preferably a hydrocracking catalyst, the method at least comprising the steps of: a) providing a zeolite Y having a bulk silica to alumina molar ratio (SAR) of at least 10; b) contacting the zeolite Y provided in step a) with a base and a surfactant, thereby obtaining a zeolite Y with increased mesoporosity; c) shaping the zeolite Y with increased mesoporosity as obtained in step b) thereby obtaining a shaped 10 catalyst carrier; d) calcining the shaped catalyst carrier as obtained in step c) in the presence of the surfactant of step b), thereby obtaining a calcined catalyst carrier; e) impregnating the catalyst carrier calcined in step d) with a noble metal component thereby obtaining a supported catalyst.

The present invention relates to a method of preparing a supported catalyst, preferably a hydrocracking catalyst.

Various methods of preparing supported catalysts are known in the art.

As an example, US20130292300A1 discloses mesostructured zeolites, methods for preparing catalyst compositions from such mesostructured zeolites and the use of such catalyst compositions in hydrocracking processes. According to Examples 7&8 of US20130292300A1 (which describe small scale experiments), a mesostructured zeolite material was prepared starting from a zeolite Y (CBV-720; having a SAR of 30) and whilst using CTAB (as surfactant) and NH₄OH (as base). After contacting with the surfactant and base, the mesostructured zeolite Y was washed, dried and calcined and subsequently impregnated with nickel oxide (NiO) and molybdenum trioxide (MoO₃) to form several different hydrocracking catalysts. As is clear from Examples 7&8 of US20130292300A1, the mesostructured zeolite Y was calcined before shaping. As a result of the calcination before shaping, the organic surfactant is removed and, consequently, no surfactant was present at the time of shaping the catalyst carrier.

WO2014098820A1 discloses a method of preparing a hydrocracking catalyst comprising a zeolite Y which exhibits a low so-called ‘small mesoporous peak height’ around the 40 Å range.

WO2017027499 discloses a second-stage hydrocracking catalyst comprising a specific zeolite beta, a zeolite USY, a catalyst support and 0.1 to 10 wt. % noble metal.

EP0963249A1 (also published as WO9839096) relates to a process for the preparation of a catalyst composition. In Example 3, a hydrocracking catalyst is prepared comprising zeolite beta, VUSY zeolite (having a silica to alumina ratio of 9.9) and alumina impregnated with Pt and Pd.

There is a continuous desire to improve the hydrocracking properties of hydrocracking catalysts.

It is an object of the present invention to meet the above desire.

It is a further object of the present invention to provide an alternative method for preparing a supported catalyst, in particular for use as a hydrocracking catalyst.

It is an even further object of the present invention to provide a method of preparing a supported catalyst, preferably a hydrocracking catalyst, which hydrocracking catalysts exhibits improved Middle Distillate (MD) selectivity.

One or more of the above or other objects can be achieved by providing a method of preparing a supported catalyst, preferably a hydrocracking catalyst, the method at least comprising the steps of:
a) providing a zeolite Y having a bulk silica to alumina molar ratio (SAR) of at least 10;
b) contacting the zeolite Y provided in step a) with a base and a surfactant, thereby obtaining a zeolite Y with increased mesoporosity;
c) shaping the zeolite Y with increased mesoporosity as obtained in step b) thereby obtaining a shaped catalyst carrier;
d) calcining the shaped catalyst carrier as obtained in step c) in the presence of the surfactant of step b), thereby obtaining a calcined catalyst carrier;
e) impregnating the catalyst carrier calcined in step d) with a noble metal component thereby obtaining a supported catalyst.

It has now surprisingly been found according to the present invention that the supported catalyst as prepared by the method according to the present invention provides for a significant higher middle distillate (MD) selectivity (150° C.-370° C.) when used in the hydroconversion of a hydrocarbonaceous feedstock.

In step a) of the method according to the present invention, a zeolite Y having a bulk silica to alumina molar ratio (SAR) of at least 10 (as determined by XRF (X-ray fluorescence)) is provided.

The person skilled in the art will readily understand that this zeolite Y (which has a faujasite structure) can vary widely. Also, it would be possible to combine the zeolite Y with a different zeolite (e.g. zeolite beta). However, the amount of zeolite Y used according to the present invention preferably makes up at least 75 wt. % of the total amount of zeolite, more preferably at least 90 wt. %, even more preferably at least 95 wt. % or even at least 98 wt. %.

Typically, the zeolite Y as used in step a) according to the present invention has a unit cell size in the range of from 24.20 to 24.50 Å. The unit cell size for a faujasite zeolite is a common property and is assessable to an accuracy of ±0.01 Å by various standard techniques. The most common measurement technique is by X-ray diffraction (XRD) following the method of ASTM D3942-80.

Further, the zeolite Y typically has a surface area of at least 650 m²/g (as measured by the well-known BET adsorption method of ASTM D4365-95, whilst using argon instead of nitrogen and with argon adsorption at a p/p0 value of 0.03), preferably at least 700 m²/g, more preferably at least 750 m²/g, and typically below 1050 m²/g.

Also, the zeolite Y typically has a crystallinity of at least 40% (for example as determined according to X-ray diffraction (XRD) utilizing ASTM D3906-97, whilst taking as standard a commercial zeolite Y of the same unit cell size), preferably at least 50%.

Furthermore, the zeolite Y typically has an alkali level of at most 0.5 wt. %, preferably at most 0.2 wt. %, more preferably at most 0.1 wt. % (as determined according to XRF).

Further, the zeolite Y typically has a total pore volume of at least 0.4 ml/g (as determined by single-point Argon desorption measurements at P/P0=0.99).

As mentioned above, the zeolite Y provided in step a) has a bulk silica to alumina molar ratio (SAR) of at least 10 (for example as determined by XRF); typically, the zeolite Y has a SAR of below 200. Preferably, the zeolite Y provided in step a) has a bulk silica to alumina molar ratio (SAR) of 20 to 100. More preferably, the zeolite Y provided in step a) has a SAR of above 40, even more preferably above 70.

In step b) of the method according to the present invention, the zeolite Y provided in step a) is contacted with a base and a surfactant, thereby obtaining a zeolite Y with increased mesoporosity.

This step b) is intended to increase the mesoporosity of the zeolite Y of in step a). According to IUPAC nomenclature, a mesoporous material is a material containing pores with diameters between 2 and 50 nm; however, as the increase of the mesoporosity of the zeolite Y occurs in particular in the pores between 2-8 nm, the present invention also specifically focusses on this pore range. As the person skilled in the art is familiar with increasing mesoporosity of zeolites, this is not discussed here in detail; a general description of increasing mesoporosity is discussed in for example US20070227351A1. The person skilled in the art will also understand that the contacting of the zeolite Y in step b) can be varied widely. Typically, an aqueous slurry of the zeolite Y is obtained by mixing water, base, surfactant and zeolite Y, the sequence of which may be varied. As a mere example, the zeolite Y may be added to a pre-prepared aqueous basic solution of surfactant, or the base may be added after the zeolite Y has first been added to an aqueous solution of surfactant.

The person skilled in the art will readily understand that the base as used in step b) may vary widely. Suitable bases to be used are for example alkali hydroxides, alkaline earth hydroxides, NH₄OH and tetraalkylammonium hydroxides.

Furthermore, the person skilled in the art will also readily understand that the surfactant may vary widely and may include a cationic, ionic or neutral surfactant. Preferably, the surfactant is a cationic surfactant. Further, it is preferred that the surfactant comprises a quaternary ammonium salt. Especially suitable surfactants are quaternary ammonium salts having 8-25 carbon atoms.

In a preferred embodiment of the method according to the present invention, the surfactant as used in step b) comprises an alkylammonium halide. Preferably, the alkylammonium halide contains at least 8 carbon atoms and typically below 25 carbon atoms. Preferably, the surfactant is selected from CTAC (cetyltrimethylammonium chloride) and CTAB (cetyltrimethylammonium bromide), and is preferably CTAC.

If desired, the aqueous solution may also contain a ‘swelling agent’, i.e. a compound that is capable of swelling micelles. Such a swelling agent may vary widely and may suitably be selected from the group consisting of: i) aromatic hydrocarbons and amines having from 5 to 20 carbon atoms, and halogen- and C₁₋₁₄ alkyl-substituted derivatives thereof (a preferred example being mesitylene); ii) cyclic aliphatic hydrocarbons having from 5 to 20 carbon atoms, and halogen- and C₁₋₁₄ alkyl-substituted derivatives thereof; iii) polycyclic aliphatic hydrocarbons having from 6 to 20 carbon atoms, and halogen- and C₁₋₁₄ alkyl-substituted derivatives thereof; iv) straight and branched aliphatic hydrocarbons having from 3 to 16 carbon atoms, and halogen- and C₁₋₁₄ alkyl-substituted derivatives thereof; v) alcohols, and derivatives thereof, preferably a C₈-C₂₀ alcohol, more preferably a C₁₀-C₁₈ alcohol and derivatives thereof; and vi) combinations thereof. According to an especially preferred embodiment of the present invention, in step b) the zeolite Y is mixed with a C₈-C₂₀ alcohol, preferably a C₁₀-C₁₈ alcohol.

The person skilled in the art will understand that the contacting conditions and time duration in step b) are not particularly limited and may vary widely. Typically, the contacting takes places from room temperature to temperatures of 200° C. and pressures of 0.5 to 5.0 bara, preferably atmospheric pressure. The time duration of the contacting is typically in the range of from 30 minutes to 10 hours. The pH of the obtained slurry is typically in the range of 9.0-12.0, preferably above 10.0 and preferably below 11.0.

If desired, before the shaping in step c), the water content of the slurry obtained in step b) is reduced thereby obtaining solids with reduced water content. The person skilled in the art will readily understand that this water reduction step is not particularly limited. Typically, this water reduction step is achieved by drying, filtration or adding a binder (or a combination thereof).

Although the binder (if used) is not particularly limited, the binder preferably comprises (and preferably even consists of) one or more non-zeolitic inorganic oxides. Preferably, the non-zeolitic inorganic oxide(s) make up more than 90 wt. % of the binder, more preferably more than 95 wt. %. Exemplary non-zeolitic inorganic oxides are alumina, silica, silica-alumina, zirconia, clays, aluminium phosphate, magnesia, titania, silica-zirconia, silica-boria. Preferably, the binder comprises a component selected from the group consisting of silica-alumina and amorphous silica-alumina.

Preferably, the binder has an acidity of less than 100 micromole/gram as determined with IR (H/D exchange through C₆D₆ as described in Chem. Commun., 2010, 46, 3466-3468).

Typically, if added, the binder is added in an amount of from 75 to 95 wt. %, on dry weight basis and based on the combined weight of (non-zeolitic) binder and zeolite.

If desired, there may be (optional) washing steps, e.g. in order to remove halide and/or alkali ions.

Typically, the zeolite Y with increased mesoporosity as obtained in step b) has a Small Mesopore (30 to 50 Å pore diameters) Peak of at least 0.07 cm³/g as determined according to Ar adsorption according to NLDFT. According to a preferred embodiment of the present invention, the zeolite Y with increased mesoporosity as obtained in step b) has a Small Mesopore (30 to 50 Å pore diameters) Peak of at least 0.20 cm³/g as determined according to Ar adsorption according to NLDFT, preferably at least 0.30 cm³/g, more preferably at least 0.40 cm³/g, even more preferably at least 0.45 cm³/g. This property has been described in the above WO2014098820A1 (see e.g. paragraph [0027] thereof) and is defined as the maximum pore volume value (in cm³/g) calculated as dV/dlogD (y-axis) using an Argon adsorption plot (pore volume vs. pore diameter) between the 30 Å and 50 Å pore diameter range (x-axis). For the definition of this property further reference is made to WO2014098820A1.

According to an especially preferred embodiment of the method according to the present invention, the zeolite Y with increased mesoporosity as obtained in step b) has a total mesopore volume in pores with a volume of 2-8 nm as determined according to Ar adsorption method according to Argon-NLDFT of at least 0.2 ml/g, preferably in the range of 0.30-0.65 ml/g.

Further, the zeolite Y with increased mesoporosity as obtained in step b) has a ratio of total mesopore volume in pores with a volume of 2-8 nm/total pore volume (as determined by single-point Argon desorption at P/PO=0.99) of typically 0.55-0.85 and preferably below 0.70.

Further it is preferred that the zeolite Y with increased mesoporosity as obtained in step b) has a ratio of Vₛ/Vₗ of at least 1.0, preferably at least 5.0, wherein Vₛ represents small mesopores with a mean diameter of 3 to 5 nm and Vₗ represents large mesopores with a mean diameter of 10 to 50 nm. These Vₛ and Vₗ values can be calculated using an Argon adsorption plot.

Also, it is preferred that the zeolite Y with increased mesoporosity as obtained in step b) has a ratio of Vₛ/(Vₛ+Vₗ) of at least 50%, preferably at least 70%, wherein Vₛ represents small mesopores with a mean diameter of 3 to 5 nm and Vₗ represents large mesopores with a mean diameter of 10 to 50 nm. Again, these Vₛ and Vₗ values can be calculated using an Argon adsorption plot.

In step c) of the method according to the present invention, the zeolite Y with increased mesoporosity as obtained in step b) is shaped thereby obtaining a shaped catalyst carrier.

As the person skilled in the art is familiar with the shaping of a catalyst carrier, this is not discussed here in detail. Typically, the shaping is done by extrusion using an extruder to thereby obtain the desired shapes (e.g. cylindrical or trilobal).

In contrast to Examples 7 and 8 of US20130292300A1 the method according to the present invention involves the shaping of the catalyst carrier with the non-calcined zeolite, providing additional benefits in terms of not requiring a challenging calcination of high-carbon containing powders and a surprising benefit in terms of hydrocracking performance.

Preferably, the surfactant content—expressed as carbon content of the modified zeolite and determined according to ASTM D5291—at the time of shaping in step c) is at least 15 wt. % on dry-zeolite basis, preferably at least 20 wt. %.

In step d) of the method according to the present invention, the shaped catalyst carrier obtained in step c) is calcined in the presence of the surfactant of step b), thereby obtaining a calcined catalyst carrier. Preferably, the surfactant content—again expressed as carbon content of the modified zeolite and determined according to ASTM D5291—at the time of calcining in step d) is at least 15 wt. % on dry-zeolite basis.

As the person skilled in the art is familiar with the calcination conditions of a shaped catalyst carrier, this is not discussed here in detail. Typically, the calcination in step d) takes place at a temperature above 300° C. Preferably, the calcination in step d) takes place at a temperature above 500° C., more preferably above 20 600° C., typically below 1000° C., preferably below 900° C., more preferably below 850° C. Typical calcination periods are from 30 minutes to 10 hours. Typical calcination pressures are from 0.5 to 5.0 bara, preferably at atmospheric pressures.

In step e) of the method according to the present invention, the catalyst carrier calcined in step d) is impregnated with a noble metal component thereby obtaining a supported catalyst.

As the person skilled in the art is familiar with the impregnating of a catalyst carrier with a hydrogenation component such as a noble metal component (which typically is followed by a calcination step), this is not discussed here in detail.

Typically, the calcination after the impregnation in step e) takes place at a temperature between 300° C. and 600° C., preferably below 500° C. Typical calcination periods are from 30 minutes to 10 hours. Typical calcination pressures are from 0.5 to 5.0 bara, preferably at atmospheric pressures.

Preferably, the noble metal in the noble metal component used in the impregnating step e) comprises at least one metal selected from the group consisting of ruthenium (Ru), rhodium (Rh), palladium (Pd), silver (Ag), osmium (Os), iridium (Ir), platinum (Pt) and gold (Au) or a combination thereof. Even more preferably, the noble metal comprises at least one metal selected from the group consisting of ruthenium (Ru), rhodium (Rh), palladium (Pd) and platinum (Pt) or a combination thereof, more preferably at least one of palladium (Pd) and platinum (Pt).

The supported catalyst may—in addition to the noble metal component—also be impregnated with a non-noble metal hydrogenation component. Again, as the person skilled in the art is familiar with the impregnating of a catalyst carrier with a hydrogenation component, this is not discussed here in detail. Typically, such additional hydrogenation component comprise a metal selected from the group consisting of Group VIB and Group VIII metals. In this respect reference is made to the Periodic Table of Elements which appears on the inside cover of the CRC Handbook of Chemistry and Physics (‘The Rubber Handbook’), 66^{th} edition and using the CAS version notation. Examples of non-noble Group VIB metals are molybdenum and tungsten and examples of non-noble Group VIII metals are cobalt and nickel.

The obtained supported catalyst may contain up to 50 parts by weight of hydrogenation component, calculated as metal per 100 parts by weight (dry weight) of total catalyst composition. Preferably, the obtained supported catalyst contains from 0.5 to 5 parts by weight of noble metal component, calculated as metal per 100 parts by weight (dry weight) of total catalyst composition.

A preferred feature of the present invention is that no heat treatment at a temperature of above 500° C. takes place between the contacting of step b) and the shaping of step c). Hereby, the surfactant is not removed as would be the case if calcination would take place between the contacting of step b) and the shaping of step c).

Preferably, no heat treatment at a temperature of above 300° C. takes place between the contacting of step b) and the shaping of step c); preferably, no heat treatment at a temperature of above 250° C. takes place between the contacting of step b) and the shaping of step c); even more preferably, no heat treatment at a temperature of above 200° C. takes place between the contacting of step b) and the shaping of step c).

In a further aspect, the present invention provides a supported catalyst obtainable by the method according to any of the preceding claims, wherein the supported catalyst contains zeolite Y and a noble metal component.

Preferably, the zeolite Y has a ratio of Vₛ/Vₗ of at least 1.0, preferably at least 5.0, wherein Vₛ represents small mesopores with a mean diameter of 2 to 5 nm and Vₗ represents large mesopores with a mean diameter of 10 to 50 nm.

Further it is preferred that the zeolite Y has a ratio of Vₛ/(Vₛ+Vₗ) of at least 50%, preferably at least 70%, wherein Vₛ represents small mesopores with a mean diameter of 2 to 5 nm and Vₗ represents large mesopores with a mean diameter of 10 to 50 nm.

In an even further aspect, the present invention provides a process for the conversion of a hydrocarbonaceous feedstock into lower boiling materials, which process comprises contacting the feedstock with hydrogen at elevated temperature and pressure in the presence of a catalyst as obtained in the method according to the present invention.

As the person skilled in the art is familiar with the process for the conversion of a hydrocarbonaceous feedstock into lower boiling materials, this is not discussed here in detail. Examples of such processes comprise single-stage hydrocracking, two-stage hydrocracking and series-flow hydrocracking as defined on page 602 and 603 of Chapter 15 (entitled “Hydrocarbon processing with zeolites”) of “Introduction to zeolite science and practice” edited by Van Bekkum, Flanigen, Jansen; published by Elsevier in 1991.

Typically, the contacting takes places at (elevated) temperatures of 250 to 450° C. and a pressure of 3×10⁶ to 3×10⁷ Pa. A space velocity in the range from 0.1 to 10 kg feedstock per litre catalyst per hour (kg·l⁻¹·h⁻¹) is conveniently used. The ratio of hydrogen gas to feedstock (total gas rate) used is typically in the range from 100 to 5000 Nl/kg.

The hydrocarbonaceous feedstocks useful in the present process can vary within a wide boiling range and include atmospheric gas oils, coker gas oils, vacuum gas oils, deasphalted oils, waxes obtained from a Fischer-Tropsch synthesis process, long and short residues, catalytically cracked cycle oils, thermally or catalytically cracked gas oils, syncrudes, etc. and combinations thereof. The feedstock will generally comprise hydrocarbons having a boiling point of at least 330° C.

Hereinafter the invention will be further illustrated by the following non-limiting examples.

### EXAMPLES

### Zeolite Modifications

CBV-780, a zeolite Y material, was obtained from Zeolyst International B.V (Delfzijl, The Netherlands). The properties of this zeolite Y material are given in Table 1 below.

TABLE 1
Properties of zeolite Y material CBV-
780 (as taken from supplier's website)

| | SiO₂/Al₂O₃ | Nominal | | Unit cell | Surface |
|---|---|---|---|---|---|
| | mole ratio | cation | Na₂O | size | Area |
| | (SAR) | form | [wt. %] | [Å] | [m²/g] |
| CBV-780 | 80 | hydrogen | 0.03 | 24.24 | 780 |

Modified Zeolite 1 (In Line with the Present Invention)

An aqueous solution 48 g CTAC (25% solution in water; commercially available from Sigma-Aldrich) and 155 g demi-water was made. To this solution 20 g CBV-780 zeolite (on a dry weight basis) was added and the obtained slurry was heated to 80° C., while being magnetically stirred.

After one hour at 80° C., 3.2 g NaOH (50% solution in demi-water, prepared with NaOH pellets (VWR Chemicals)) was added and the slurry was stirred for 4 hours at 80° C. Thereafter, the hot slurry was quenched with cold (about 20° C.) demi-water, and filtered and washed thoroughly with demi-water. The filtrate was resuspended in 200 g demi-water and heated to 70° C. while being magnetically stirred. After reaching 70° C., 0.1 g HNO₃ (commercially available in 65% solution in water from Merck KGaA) was added per gram zeolite (total 3.08 g 65% HNO₃). After one hour at 70° C., the slurry was filtered and washed thoroughly with demi-water. The obtained mesoporous zeolite is referred to with ‘MZ1’ or ‘780mp’.

Modified Zeolite MZ1-C (In Line with the Present Invention, but Less Preferred)

A portion of the ‘MZ1’ (780mp) was dried at 120° C. and subsequently calcined at 760° C. for 1 hour under N₂ atmosphere and subsequently calcined under air at 550° C. for 1 hours. This calcined sample is referred to with ‘MZ1-C’ or ‘780mp-C’.

Modified Zeolite 2 (In Line with the Present Invention)

An aqueous solution of 72 g CTAC (25% solution in water; Sigma-Aldrich) and 232 g water was made, to which cetyl alcohol (‘CA’; synthesis grade, commercially available from Sigma Aldrich (Zwijndrecht, The Netherlands)) was added as swelling agent in a CA/CTAC molar ratio of 0.5. To this solution 30 g CBV-780 zeolite (on a dry weight basis) was added, and the slurry was heated up to 80° C. while being magnetically stirred. After one hour at 80° C., 4.8 g NaOH (50% solution in demi-water, prepared with NaOH pellets (VWR Chemicals)) was added and the slurry was stirred for 4 hours at 80° C. Thereafter, the hot slurry was quenched with cold (about 20° C.) demi-water, and filtered and washed thoroughly with demi-water. The filtrate was resuspended in 300 g demi-water and heated to 70° C. while being magnetically stirred. After reaching 70° C., 0.1 gram HNO₃ (commercially available in 65% solution from Merck KGaA (Darmstad, Germany)) was added per gram zeolite (total of 4.6 g 65% HNO₃). After one hour at 70° C., the slurry was filtered and washed thoroughly with demi-water. The as-obtained modified zeolite Y is referred to with ‘MZ2’ or ‘780mpSA’ (i.e. treated with a swelling agent).

### Powder Analysis of (Modified) Zeolite Y

Prior to powder analysis, all samples were dried at 120° C., calcined at 760° C. for 1 hour under an N₂ atmosphere and subsequently calcined under air at 550° C. for 2 hours using the two-step calcination procedure, similar to Example 7 of US20130292300A1. This, to remove the surfactant and enable accessibility for sorption experiments.

The following tests/apparatus were used for the analysis:

Pore Volumes:

Total pore volume (‘Total PV’) and mesopore volume (‘mesoPV’) were determined by Argon physisorption.

To this end, sorption experiments were performed with argon (−186° C.) using a Micromeritics 3FLEX Version 4.03 apparatus. Prior to the adsorption experiments, the samples were outgassed for at least 12 hours under vacuum at 350° C.

For determining the ‘Total PV’ single-point Argon desorption data at P/PO=0.99 was used.

For determining the ‘mesoPV’ (in 2-8 nm, 3-5 nm and 10-50 ranges) Argon adsorption data was used, using the HS-2D-NLDFT, Cylindrical oxide, Ar, 87 model from Micromeritics. From this data also the average pore size in the 2-8 nm pore range was calculated. For the ratio ‘mesoPV/Total PV’, the mesoPV in the 2-8 nm pore range was used.

Argon Surface Area:

The surface area was determined through Argon adsorption in accordance with the conventional BET (Brunauer-Emmett-Teller) method adsorption technique as described in the literature by S. Brunauer, P. Emmett and E. Teller, J. Am. Chm. Soc., 60, 309 (1938), and ASTM method D4365-95. Surface areas were determined at P/P0=0.03.

Unit Cell Parameter A0:

XRD analysis, e.g. in accordance with ASTM D3942-80, was used to determine the unit cell constant.

The samples were measured on an X′Pert diffractometer from Malvern Panalytical. The samples were measured in a powdered, homogenized form.

Samples and reference samples (i.e. the untreated parent zeolites) were kept inside a closed radiation cabinet of the diffractometer for at least 16 hours to ensure equal equilibration with the ambient conditions of the cabinet.

Crystallinity:

XRD analysis was used to determine crystallinity.

The crystallinity was determined by comparing the total diffracted intensity of the diffraction pattern of a sample to that of a reference sample (the corresponding parent zeolite). The intensity ratio was reported as a percentage of the reference intensity.

Bulk silica to Alumina Molar Ratio (SAR):

The bulk silica to alumina molar ratio (SAR) can be determined through various techniques such as ICP, AAS and XRF resulting in similar outcomes. Here, XRF analysis was applied using a 4 kW WD-XRF analyser.

The results are given in Table 2 below.

TABLE 2
overview of (modified) zeolite Y properties. ‘Parent’
means untreated commercial zeolite.

| | CBV-780 | MZ1 | MZ2 |
|---|---|---|---|
| Zeolite/Modified zeolite | (parent) | (780 mp) | (780 mp) |
| Exposure time to NaOH [h] | — | 4 | 4 |
| CA/CTAC molar ratio | — | 0 | 0.5 |
| Total PV (by Ar | 0.51 | 0.73 | 0.89 |
| desorption) [ml/g] | | | |
| mesoPV [ml/g] in 2-8 nm | 0.04 | 0.58 | 0.46 |
| pore range | | | |
| Small mesoPV [ml/g] in 3-5 | 0.01 | 0.50 | 0.09 |
| nm pore range (Vₛ) | | | |
| Large mesoPV [ml/g] in 10- | 0.08 | 0.00 | 0.06 |
| 50 nm pore range (Vₗ) | | | |
| mesoPV/Total PV [%] | 8 | 79 | 52 |
| Vₛ/Vₗ | 0.16 | (infinite) | 1.5 |
| Vₛ/(Vₛ + Vₗ) [%] | 30 | 100 | 72 |
| Argon surface area [m²/g] | 750 | 812 | 670 |
| Average pore size in 2-8 | 2.6 | 4.2 | 4.9 |
| nm pore range [nm] | | | |
| A0 [Å], by XRD | 24.27 | 24.30 | 24.32 |
| Crystallinity (%) vs | 100* | 46 | 40 |
| parent zeolite Y, by XRD | | | |
| SAR (by XRF) | 83 | 90 | 89 |

*per definition

### Preparation of Carriers and Hydrocracking Catalysts

Several hydrocracking catalysts were made. Firstly, a catalyst carrier (i.e. extruded and calcined extrudate comprising zeolite and ASA as binder) was prepared with commercially available zeolite or with the modified zeolite as prepared above, whilst using the amounts of zeolite and ASA as indicated in Table 3 below. The catalyst carriers were prepared in amounts of about 15 g. The ASA used had a surface area of 500 m²/g, a pore volume of 1.03 ml/g, an apparent bulk density of 0.24 g/ml and comprised 45% silica and 55% alumina.

As peptizing agents and extrusion aids, 1 wt. % acetic acid (Merck KGaA), 1 wt. % nitric acid (Merck KgaA), 0.5 wt. % PVA (5% aq Mowiol® 18-88) and 1 wt. % methylcellulose (K15M, available from the Dow Chemical Company) were used to prepare the carriers for making catalysts with parent zeolite (see Comparative Examples 1-4 in Table 3).

For the carriers and catalysts with modified zeolites, 2.25% nitric acid (Merck KgaA), 0.5 wt. % PVA (5% aq Mowiol® 18-88) and 1 wt. % methylcellulose (K15M) was used.

After mixing the zeolites with the ASA, a shaped catalyst carrier was obtained by extrusion into trilobe shaped extrudate with a diameter of 1.6 mm. The obtained shaped catalyst carriers were calcined at 650° C. for 1 hour.

Subsequently, the hydrogenation components were added to the calcined catalyst carriers through aqueous incipient wetness impregnation.

For the non-noble metal catalysts an impregnation solution of nickel carbonate (commercially available from Umicore (Belgium), ammonium metatungstate (commercially available from Sigma-Aldrich) and citric acid (VWR Chemicals) was used. The citric acid and Ni were added in a 1:1 molar ratio, aiming for a loading of 4 wt. % Ni and 19 wt. % W. After drying at 120° C., the catalysts were calcined at 450° C. for 2h.

For the noble metal catalysts an impregnation solution of platinum tetra-ammonium nitrate (commercially available from Heraeus, Germany) was used, aiming for a loading of 0.7 wt. % Pt. After drying at 120° C., the catalysts were calcined at 450° C. for 2 h.

TABLE 3
Catalysts

| | | | Zeolite Y | ASA |
|---|---|---|---|---|
| | | | content (in | content (in |
| Carrier and | Hydrogenation | | catalyst | catalyst |
| catalyst | metal | (modified) | carrier) | carrier) |
| preparation | [wt. %] | zeolite Y used | [wt. %] | [wt. %] |
| Comp. Ex. 1 | 4% Ni/19% W | CBV-780 (parent) | 5 | 95 |
| Comp. Ex. 2 | 4% Ni/19% W | CBV-780 (parent) | 15 | 85 |
| Comp. Ex. 3 | 0.7% Pt | CBV-780 (parent) | 5 | 95 |
| Comp. Ex. 4 | 0.7% Pt | CBV-780 (parent) | 15 | 85 |
| Comp. Ex. 5 | 4% Ni/19% W | MZ1 | 10 | 90 |
| Comp. Ex. 6 | 4% Ni/19% W | MZ2 | 10 | 90 |
| Comp. Ex. 7 | 4% Ni/19% W | MZ1-C | 15 | 85 |
| Ex. 1 | 0.7% Pt | MZ1 | 10 | 90 |
| Ex. 2 | 0.7% Pt | MZ1-C | 15 | 85 |
| Ex. 3 | 0.7% Pt | MZ2 | 10 | 90 |

### Catalytic Testing

The hydrocracking performance of the catalysts of the present invention was assessed in a test.

In the test, a second stage of a two-stage simulation was performed in which inventive and comparative catalysts were evaluated. The testing was carried out in once-through nanoflow equipment which had been loaded with a catalyst bed comprising 0.6 ml of the test catalyst diluted with 0.6 ml Zirblast (B120; commercially available from Saint-Gobian ZirPro (France)).

NiW Catalysts

Prior to loading, the NiW catalysts were pre-sulfided in situ prior to testing through gas phase sulfidation: pre-sulfiding was performed at 15 barg in gas phase (5 vol. % H₂S in hydrogen), with a ramp of 20° C./h from room temperature (20° C.) to 135° C., and holding for 12 hours before raising the temperature to 280° C., and holding again for 12 hours before raising the temperature to 355° C. again at a rate of 20° C./h. Afterwards, the reactor was allowed to cool down to room temperature, opened to air, and subsequently loaded in a nanoflow reactor using the dilution as described above.

Pt Catalysts

The Pt catalysts were loaded as calcined in the nanoflow reactor and were reduced in situ in hydrogen (100% H₂, 60 barg), with a ramp of 25° C./h from room temperature (20° C.) to 150° C., and holding for 2 hours before raising the temperature to 350° C. at 50° C./h, and holding again for 8 hours before cooling to 160° C. to start wetting the catalyst with feedstock.

The test involved the contacting of a hydrocarbonaceous feedstock (a hydrotreated heavy gas oil) with the catalyst bed in a once-through operation under the following process conditions:
a space velocity of 1.5 kg heavy gas oil per liter catalyst per hour (kg.l⁻¹.h⁻¹);
a hydrogen gas/heavy gas oil ratio of 1500 Nl/kg;
50 ppmV H₂S obtained by spiking the feed with Sulfrzol S54 (obtained from Lubrizol); and
a total pressure of 14×10⁶ Pa (140 bar).

The hydrotreated heavy gas oil used had the following properties:
Carbon content: 85.86 wt. %
Hydrogen content: 14.14 wt. %
Nitrogen (N) content: 0.3 ppmw
Added Sulfrzol (0.186 g/kg sulfrzol 54) to achieve 50 ppmV H₂S in the gas phase
Density (70° C.): 0.812 g/ml
Mono-aromatic rings: 0.75 wt. %
Di+-aromatics rings: 0.68 wt. %
Initial boiling point: 297° C.
50% w boiling point: 429° C.
Final boiling point: 580° C.
Fraction boiling below 370° C.: 11.6 wt. %
Fraction boiling above 540° C.: 3.83 wt. %

Hydrocracking performance was assessed at conversion levels between 30 and 70 wt. % net conversion of feed components boiling above 370° C. The experiments were carried out at different temperatures to obtain 55 wt. % net conversion of feed components boiling above 370° C. in all experiments by interpolation. Table 4 below shows the results obtained for the catalysts as listed in Table 3 above.

TABLE 4
Hydrocracking performance

| | C. Ex. 1 | C. Ex. 2 | C. Ex. 3 | C. Ex. 4 | C. Ex. 5 | C. Ex. 6 | C. Ex. 7 | Ex. 1 | Ex. 2 | Ex. 3 |
|---|---|---|---|---|---|---|---|---|---|---|
| (Modified) zeolite Y | CBV-780 | CBV-780 | CBV-780 | CBV-780 | MZ1 | MZ2 | MZ1-C | MZ1 | MZ1-C | MZ2 |
| Zeolite Y content [wt. %] | 5 | 15 | 5 | 15 | 10 | 10 | 15 | 10 | 15 | 10 |
| Hydrogenation metal | NiW | NiW | Pt | Pt | NiW | NiW | NiW | Pt | Pt | Pt |
| T required for target | 364 | 343 | 348 | 331 | 368 | 367 | 362 | 361 | 354 | 359 |
| conversion¹ [° C.] | | | | | | | | | | |
| C1-C4 [wt. %] | 2.9 | 3.8 | 2.1 | 2.4 | 4.0 | 2.9 | 3.3 | 2.7 | 2.1 | 2.0 |
| C5-82° C. [wt. %] | 6.2 | 8.7 | 4.9 | 6.2 | 6.6 | 5.9 | 6.5 | 4.8 | 4.5 | 4.0 |
| 82-150° C. [wt. %] | 27.8 | 31.9 | 25.8 | 26.8 | 24.2 | 25.7 | 26.3 | 17.8 | 22.5 | 20.4 |
| 150-370° C.² [wt. % ] | 63.1 | 55.6 | 67.2 | 64.6 | 65.4 | 65.5 | 63.9 | 74.8 | 71.0 | 73.6 |
| Delta MD³ | 0* | 0* | 7.9 | 9.4 | 1.5 | 1.8 | 1.3 | 12.6 | 10.3 | 11.8 |
| diesel/kero ratio⁴ | 1.15 | 0.98 | 1.32 | 1.04 | 1.23 | 1.23 | 1.21 | 1.38 | 1.35 | 1.46 |
| [wt. %/wt. %] | | | | | | | | | | |
| k-540/k-370⁵ | 1.01 | 0.73 | 0.83 | 0.65 | 1.17 | 1.23 | 1.14 | 1.28 | 1.17 | 1.21 |
| HDA mono [wt. %] | 95.1 | 93.4 | 100.0 | 98.7 | 95.5 | 95.0 | 96.9 | 98.9 | 99.2 | 98.8 |
| HDA di [wt. %] | 98.6 | 97.3 | 100.5 | 99.5 | 99.2 | 98.9 | 99.4 | 100.0 | 100.0 | 99.8 |
| HDA tri+ [wt. %] | 88.9 | 83.7 | 85.6 | 91.7 | 89.9 | 82.9 | 91.2 | 111.2 | 95.4 | 88.0 |
| H₂ consumption [wt. %] | 0.86 | 0.93 | 0.85 | 0.88 | 0.88 | 0.82 | 0.92 | 0.83 | 0.83 | 0.86 |

¹Hydrocracking test. Target net conversion is 55 wt. %.
²Middle Distillate (MD) selectivity
³Delta MD versus reference curve
*per definition: a linear curve between the two reference data points for the catalysts made with CBV-780 was used to calculate the delta MD for the comparative (Comparative Examples 3-7) and inventive catalysts (Examples 1-3) versus the reference (Comparative Examples 1-2)
⁴250-370° C./150-250° C.
⁵ratio of rate of conversion (in kg/l/h) of >540° C. fraction vs >370° C. fraction

The results in Table 4 show that:
Comparative Examples 1 and 2 versus Comparative Examples 3 and 4 show the significant impact in MD selectivity of switching from a non-noble metal system (viz. sulfided NiW) to a noble metal catalyst (viz. Pt): a large delta in MD selectivity is observed.
Comparative Examples 5-7 show the benefit in MD selectivity of using a zeolite with increased mesoporosity over parent zeolite (Comparative Examples 1 and 2).
Examples 1 and 2 show a surprisingly high MD selectivity when combining the use of a zeolite with increased mesoporosity and a noble metal catalyst, which is larger than expected on the basis of the sum of Delta MDs: as an example, Example 1 (containing noble metal and zeolite with increased mesoporosity) shows a Delta MD of 12.6, which is significantly higher than the sum of Delta MDs for the use of noble metal (Comparative Example 3: 7.9) and zeolite with increased mesoporosity (Comparative Example 5: 1.5).
The benefit of leaving the surfactant in the zeolite until and including the catalyst carrier preparation (i.e. the ‘shaping’ of step c) is shown clearly in comparison with the catalysts made with the pre-calcined zeolite (wherein a calcination step takes place before shaping). For the catalysts of both Example 1 (Pt) and Comparative Example 5 (NiW), a higher delta MD (Ex.1: 12.6; C.Ex.5: 1.5) was observed compared to catalysts made with mesoporous zeolite which was calcined directly after mesopores had been introduced: see Ex.2 (10.3) and C.Ex.7 (1.3), respectively.
For the catalysts made with a larger average pore size (see Table 2) i.e. using zeolite MZ2) a similar benefit of using Pt and mesoporous zeolite was found (Ex. 3: delta MD=11.8), larger than the sum of the benefit of either Pt or application of a mesoporous zeolite prepared with swelling agent (C.Ex.6; delta MD=1.8). The reason for the benefit in the catalyst with swelling agent is currently not understood.

The person skilled in the art will readily understand that many modifications may be made without departing from the scope of the invention.

1. A method of preparing a supported hydrocracking catalyst, the method comprising the steps of:
a) providing a zeolite Y having a bulk silica to alumina molar ratio (SAR) of at least 10;
b) contacting the zeolite Y provided in step a) with a base and a surfactant, thereby obtaining a zeolite Y with increased mesoporosity;
c) shaping the zeolite Y with increased mesoporosity as obtained in step b) thereby obtaining a shaped catalyst carrier;
d) calcining the shaped catalyst carrier as obtained in step c) in the presence of the surfactant of step b), thereby obtaining a calcined catalyst carrier;
e) impregnating the calcined catalyst carrier obtained in step d) with a noble metal component thereby obtaining a supported catalyst.

2. The method according to claim 1, wherein the zeolite Y provided in step a) has a bulk silica to alumina molar ratio (SAR) of 20 to 100.

3. The method according to claim 1, wherein the surfactant as used in step b) comprises an alkylammonium halide.

4. The method according to claim 1, wherein the zeolite Y with increased mesoporosity as obtained in step b) has a Small Mesopore (30 to 50 Å pore diameters) Peak of at least 0.20 cm³/g as determined according to Ar adsorption according to NLDFT.

5. The method according to claim 1, wherein the zeolite Y with increased mesoporosity as obtained in step b) has a total mesopore volume in pores with a volume of 2-8 nm as determined according to Ar adsorption according to NLDFT of a range between 0.2 ml/g and 0.65 ml/g.

6. The method according to claim 1, wherein the zeolite Y with increased mesoporosity as obtained in step b) has a ratio of Vₛ/Vₗ of at least 1.0, wherein Vₛ represents small mesopores with a mean diameter of 3 to 5 nm and Vₗ represents large mesopores with a mean diameter of 10 to 50 nm.

7. The method according to claim 1, wherein the zeolite Y with increased mesoporosity as obtained in step b) has a ratio of Vₛ/(Vₛ+Vₗ) of at least 50%, wherein Vₛ represents small mesopores with a mean diameter of 3 to 5 nm and Vₗ represents large mesopores with a mean diameter of 10 to 50 nm.

8. The method according to claim 1, wherein no heat treatment at a temperature of above 500° C. takes place between the contacting of step b) and the shaping of step c.

9. The method according to claim 1, wherein the noble metal in the noble metal component used in in step e) comprises at least one metal selected from the group consisting of ruthenium (Ru), rhodium (Rh), palladium (Pd), silver (Ag), osmium (Os), iridium (Ir), platinum (Pt), gold (Au), and a combination thereof.

10. A supported catalyst obtainable by the method according to claim 1, containing zeolite Y and a noble metal component.

11. The catalyst according to claim 10, wherein the zeolite Y has a ratio of Vₛ/Vₗ of at least 1.0, wherein Vₛ represents small mesopores with a mean diameter of 2 to 5 nm and Vₗ represents large mesopores with a mean diameter of 10 to 50 nm.

12. The catalyst according to claim 10, wherein the zeolite Y has a ratio of Vₛ/(Vₛ+Vₗ) of at least 50%, wherein Vₛ represents small mesopores with a mean diameter of 2 to 5 nm and Vₗ represents large mesopores with a mean diameter of 10 to 50 nm.

13. A process for the conversion of a hydrocarbonaceous feedstock into lower boiling materials, the process comprises contacting the hydrocarbonaceous feedstock with hydrogen at elevated temperature and pressure in the presence of a catalyst as obtained in the method according to claim 1 or the catalyst of claim 10.
